(19) United States
(12) Patent Application Publication
(10) Pub. No.: US 2016/0369990 A1
(43) Pub. Date: Dec. 22, 2016

(54) REFILL INDICATION SYSTEM

(71) Applicant: Stanley Anderson, Corona, CA (US)

(72) Inventor: Stanley Anderson, Corona, CA (US)

(21) Appl. No.: 14/742,912

(22) Filed: Jun. 18, 2015

(51) Int. Cl. F21V 23/04; F21V 21/00

(52) U.S. Cl. CPC F21V 23/0442; F21V 21/00; G06Q 50/12

(57) ABSTRACT

A refill indication system includes a panel having a first side, a second side and a perimeter edge. Each of the first and second sides is planar. A support is attached to the first side adjacent to the perimeter edge and spaces the first side from a surface when the first side faces the surface and the support abuts the surface. A light emitter is mounted in the panel. A switch is electrically coupled to the light emitter. The switch is mounted on the first side and is spaced from the perimeter edge. The light emitter is turned on when the switch is actuated. The switch is actuated to an on position when an object is placed on the switch and actuated to an off position when first side is free of supporting the object.

### BACKGROUND OF THE DISCLOSURE

1. Field of the Disclosure

The disclosure relates to drink ordering facilitating devices and more particularly pertains to a new drink ordering facilitating device for signaling to a server that a patron desires another beverage.

### SUMMARY OF THE DISCLOSURE

An embodiment of the disclosure meets the needs presented above by generally comprising a panel having a first side, a second side and a perimeter edge. Each of the first and second sides is planar. A support is attached to the first side adjacent to the perimeter edge and spaces the first side from a surface when the first side faces the surface and the support abuts the surface. A light emitter is mounted in the panel. A switch is electrically coupled to the light emitter. The switch is mounted on the first side and is spaced from the perimeter edge. The light emitter is turned on when the switch is actuated. The switch is actuated to an on position when an object is placed on the switch and actuated to an off position when first side is free of supporting the object.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a refill indication system according to an embodiment of the disclosure.

FIG. 2 is a top view of an embodiment of the disclosure.

FIG. 3 is a bottom perspective in-use view of an embodiment of the disclosure.

FIG. 4 is a side view of an embodiment of the disclosure.

FIG. 5 is a bottom perspective view of an embodiment of the disclosure.

FIG. 6 is a schematic view of an embodiment of the disclosure.

### DESCRIPTION OF THE PREFERRED EMBODIMENT

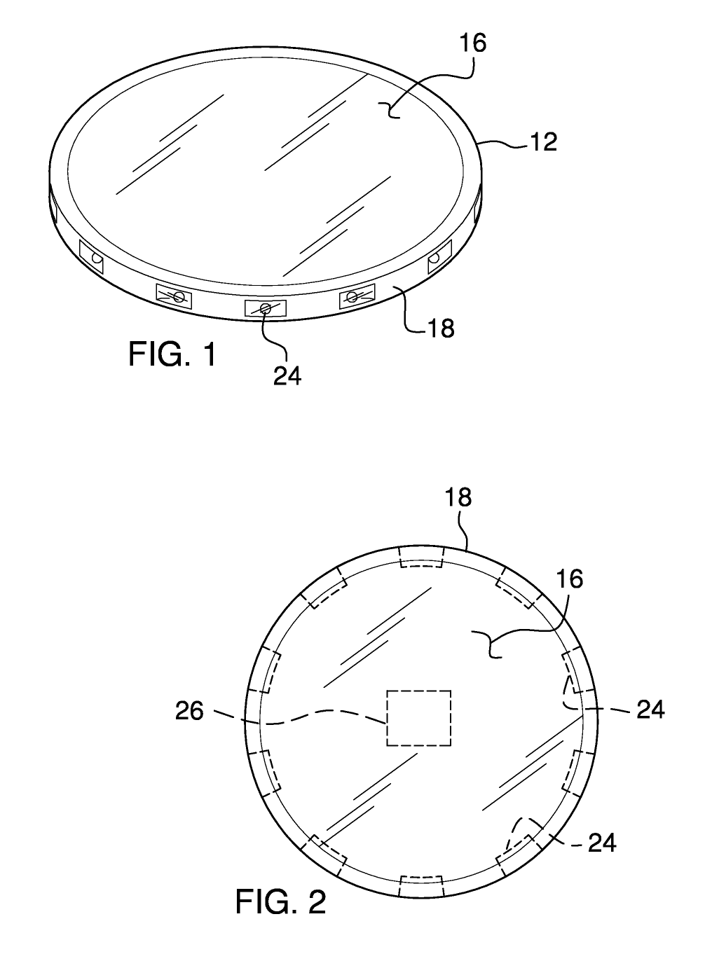

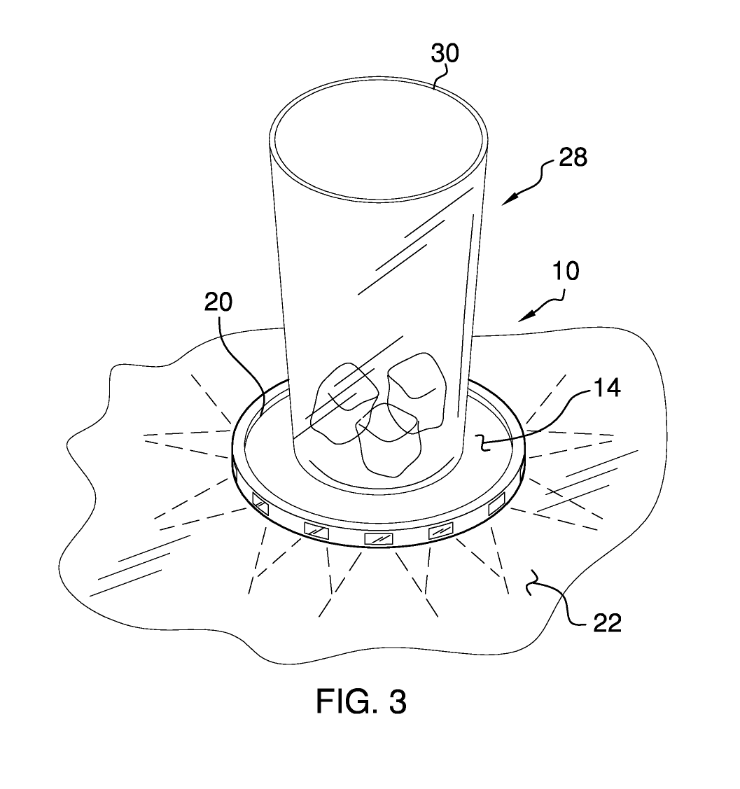

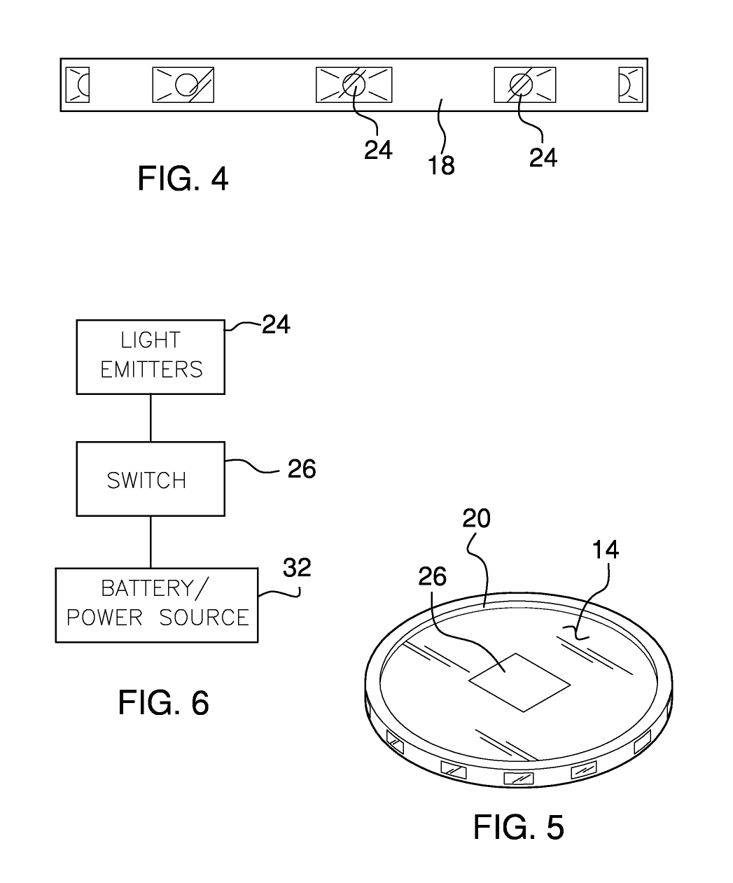

With reference now to the drawings, and in particular to FIGS. 1 through 6 thereof, a new drink ordering facilitating device embodying the principles and concepts of an embodiment of the disclosure and generally designated by the reference numeral 10 will be described.

As best illustrated in FIGS. 1 through 6, the refill indication system 10 generally comprises a panel 12 that has a first side 14, a second side 16 and a perimeter edge 18. Each of the first 14 and second 16 sides is planar. Each of the first 14 and second 16 sides has a width between 2.5 inches and 4.5 inches and the perimeter edge 18 has a height less than 0.5 inches. The first 14 and second 16 sides may each have a circular shape though other shapes may be provided for as such is not central to the functioning of the system 10. The panel 12 may be comprised of a plastic material which is translucent. The second side 16 may be comprised of a fluid absorbing material and may also be a non-slip material.

A support 20 is attached to the first side 14 adjacent to the perimeter edge 18. The support 20 spaces the first side 14 from a surface 22 when the first side 14 faces the surface 22 and the support 20 abuts the surface 22. Generally the surface 22 would be a surface of a table or counter. The support 20 extends away from the first side 14 a distance of less than 0.5 inches. The support 20 may comprise a lip that extends upwardly from the first side 14 and which is coextensive, or substantially coextensive with the perimeter edge 18. Alternatively the support 20 may comprise a plurality of legs or lip sections.

A light emitter 24 is mounted in the panel 12. The light emitter 24 may be positioned adjacent to and is directed outwardly of the perimeter edge 18. As can be seen in the Figures, the light emitter 24 may be one of a plurality of light emitters 24 and each may comprise a light emitting diode. The light emitters 24 may alternatively be directly upwardly away from the first side 14 when the first side 14 is facing upwardly. A switch 26 is electrically coupled to the light emitter 24 and is mounted on the first side 14 such that it is spaced from the perimeter edge 18. Thus, the support 20 also spaces the switch 26 from the surface 22 when the support 20 abuts the surface 22. The light emitter 24 is turned on when the switch 26 is actuated. The switch 26 is configured to be actuated to an on position when an object 28 is placed on the switch 26 and actuated to an off position when first side 14 is free of the object 28. The object 28 will typically be a drinking glass 30 of conventional configuration. The switch 26 may comprise a weight sensor which is easily sealed against fluids. A power supply 32, such as a conventional battery, is mounted in the panel 12 and is electrically coupled to the switch 26 and the light emitter 24.

In use, the user of the system 10 will use the panel 12 as a conventional coaster with the support 10 abutting the surface 22 of the table and the drinking glass 30 positioned on the second side 16 of the panel 12. When the user wishes the server to refill or replace with drinking glass 30 with another beverage, the user will turn the panel 12 over so that the second side 16 faces downwardly and the first side 14 is facing upwardly. The drinking glass 30 is placed on the switch 26 which turns on the light emitter(s) 24. The light emitters 24, once illuminated, will signal to the server that the person would like an additional beverage. The light emitters 24 may be programmed to provide a steady illumination or one that intermittently flashes on and off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A refill indication assembly configured to signal to a server that a patron would require a new drink or a drink refill, said assembly comprising:
a panel having a first side, a second side and a perimeter edge, each of said first and second sides being planar, each of said first and second sides having a width between 2.5 inches and 4.5 inches;
a support being attached to said first side adjacent to said perimeter edge, said support being configured to space said first side from a surface when said first side faces the surface and said support abuts the surface;
a light emitter being mounted in said panel; and
a switch being electrically coupled to said light emitter, said switch being mounted on said first side and being spaced from said perimeter edge, said light emitter being turned on when said switch is actuated, said switch being configured to be actuated to an on position when an object is placed on said switch and actuated to an off position when first side is free of supporting the object.

2. The refill indication assembly according to claim 1, wherein said perimeter edge has a height less than 0.5 inches.

3. The refill indication assembly according to claim 2, wherein said first and second sides each have a circular shape.

4. The refill indication assembly according to claim 2, wherein said support extends away from said first side a distance of less than 0.5 inches.

5. The refill indication assembly according to claim 4, wherein said support comprises a lip extending upwardly from said first side.

6. The refill indication assembly according to claim 5, wherein said lip is coextensive with said perimeter edge.

7. The refill indication assembly according to claim 1, wherein said switch comprises a weight sensor.

8. The refill indication assembly according to claim 1, wherein said light emitter is adjacent to and directed outwardly of said perimeter edge.

9. A refill indication assembly configured to signal to a server that a patron would require a new drink or a drink refill, said assembly comprising:
a panel having a first side, a second side and a perimeter edge, each of said first and second sides being planar, each of said first and second sides having a width between 2.5 inches and 4.5 inches, said perimeter edge having a height less than 0.5 inches, said first and second sides each having a circular shape;
a support being attached to said first side adjacent to said perimeter edge, said support being configured to space said first side from a surface when said first side faces the surface and said support abuts the surface, said support extending away from said first side a distance of less than 0.5 inches, said support comprising a lip extending upwardly from said first side, said lip being coextensive with said perimeter edge;
a light emitter being mounted in said panel, said light emitter being positioned adjacent to and being directed outwardly of said perimeter edge;
a switch being electrically coupled to said light emitter, said switch being mounted on said first side and being spaced from said perimeter edge, said light emitter being turned on when said switch is actuated, said switch being configured to be actuated to an on position when an object is placed on said switch and actuated to an off position when first side is free of supporting the object, said switch comprising a weight sensor; and
a power supply being mounted in said panel and being electrically coupled to said switch and said light emitter.
